(19) United States
(12) Patent Application Publication
(10) Pub. No.: US 2022/0051175 A1
(43) Pub. Date: Feb. 17, 2022

(54) System and Method for Mapping Risks in a Warehouse Environment

(71) Applicant: Everseen Limited, Blackpool (IE)

(72) Inventors: Alan O'Herlihy, Glenville (IE); Joe Allen, Ballybunion (IE); Dan Alexandru Pescaru, Timisoara (RO)

(73) Assignee: Everseen Limited, Blackpool (IE)

(21) Appl. No.: 16/991,210

(22) Filed: Aug. 12, 2020

(51) Int. Cl. G06Q 10/08; H04N 7/18

(52) U.S. Cl. CPC G06Q 10/087; H04N 7/181

(57) ABSTRACT

A system for identifying and managing areas of risk in warehouse environments includes video sensors configured to capture video streams and a central processing unit communicatively coupled to video sensors. The central processing unit comprises a raw risk information collection unit configured to store information captured by video sensors, a processing and aggregating unit configured to process and aggregate video streams to produce risk identification information associated with an Operator Route, a risk map generation unit configured to generate a Warehouse Risk Map based on the risk identification information, wherein the Warehouse Risk Map is generated by superimposing an identified risk zone on a warehouse map, and a risk map updating unit for updating the Warehouse Risk Map in real-time when at least one of the risk type, risk level, and risk zone changes for at least one risk instance recorded on the Warehouse Risk Map.

### TECHNICAL FIELD

The present disclosure relates generally to a warehouse or distribution environment, and more specifically to improving the efficiency of warehouse management by identifying and documenting areas of greatest risk.

### BACKGROUND

In a distribution system, order fulfillment is a key process in managing the supply chain. It includes generating, filling, delivering and servicing customer orders. A typical order fulfillment process includes various sub-processes such as receiving order, picking an order, packing an order, and shipping the order. Receiving refers to the acceptance and storage of incoming inventory at a fulfillment center. When the fulfillment center receives the inventory, the items may be stored in dedicated warehouse locations, such as pallets. A pallet is a portable, rigid platform that is flat and can carry the load. In the picking sub-process, the picking team receives a packing slip with the items, quantities, and storage locations at the facility to collect the ordered products from their respective pallets.

Also, two features influence the operational efficiency of a warehouse or distribution centre. These aspects relate to the dynamic nature of the warehouse environment, and the performance of human operators during a pallet handling/order-picking process. In view of the above, there is a need for addressing the problem of order fulfillment efficiency in a warehouse distribution system, and enabling better operational management by redesigning package handling routes, and optimisation of package handling procedures during order fulfilment.

### SUMMARY

In an aspect of the present disclosure, there is provided a system for identifying and managing areas of risk in a warehouse environment. The system may include one or more video sensors configured to capture one or more video streams thereof, to generate one or more monitored zones, and one or more uncovered zones in the warehouse environment, based on the Field of View of the one or more video sensors. The system may further include a central processing unit communicatively coupled to the one or more video sensors. The central processing unit includes a raw risk information collection unit configured to store information captured by the one or more video sensors, and a processing and aggregating unit configured to process and aggregate the one or more video streams to produce risk identification information associated with an Operator Route traversed by a warehouse operator while performing a warehouse operation, wherein the risk identification information includes at least one risk zone, and corresponding risk type, and risk level, wherein a risk zone is an area in the warehouse environment that corresponds to one or more risk instances. The system may further include a risk map generation unit configured to generate a Warehouse Risk Map based on the risk identification information, wherein the Warehouse Risk Map is generated by superimposing an identified risk zone on a warehouse map. The system may further include a risk map updating unit for updating the Warehouse Risk Map in real-time when at least one of the risk type, risk level, and risk zone changes for at least one risk instance recorded on the Warehouse Risk Map.

In another aspect of the present disclosure, there is provided a method for identifying and managing areas of risk in a warehouse environment. The method includes capturing one or more video streams thereof, to generate one or more monitored zones, and one or more uncovered zones in the warehouse environment, based on the Field of View of the one or more video sensors. The method may further include storing information captured by the one or more video sensors. The method may further include processing and aggregating the one or more video streams to produce risk identification information associated with an Operator Route traversed by a warehouse operator while performing a warehouse operation, wherein the risk identification information includes at least one risk zone, and corresponding risk type, and risk level, wherein a risk zone is an area in the warehouse environment that corresponds to one or more risk instances. The method may further include generating a Warehouse Risk Map based on the risk identification information, wherein the Warehouse Risk Map is generated by superimposing an identified risk zone on a warehouse map. The method may further include updating the Warehouse Risk Map in real-time when at least one of the risk type, risk level, and risk zone changes for at least one risk instance recorded on the Warehouse Risk Map.

In yet another aspect of the present disclosure, there is provided a computer programmable product for identifying and managing areas of risk in a warehouse environment, the computer programmable product comprising a set of instructions. The set of instructions when executed by a processor causes the processor to capture one or more video streams thereof, to generate one or more monitored zones, and one or more uncovered zones in the warehouse environment, based on the Field of View of the one or more video sensors, store information captured by the one or more video sensors, process and aggregate the one or more video streams to produce risk identification information associated with an Operator Route traversed by a warehouse operator while performing a warehouse operation, wherein the risk identification information includes at least one risk zone, and corresponding risk type, and risk level, wherein a risk zone is an area in the warehouse environment that corresponds to one or more risk instances, generate a Warehouse Risk Map based on the risk identification information, wherein the Warehouse Risk Map is generated by superimposing an identified risk zone on a warehouse map, and update the Warehouse Risk Map in real-time when at least one of the risk type, risk level, and risk zone changes for at least one risk instance recorded on the Warehouse Risk Map.

Various embodiments of the present disclosure perform analysis of known and observed potentially changing environmental and human risk factors to generate and update a spatially defined risk map in a warehouse environment. By relating risk factor information to spatial information, the present disclosure allows causative correlations to be drawn between observed performance variables and specific locations within the warehouse environment or areas proximal thereto. The risk map may be used to detect and identify current and future potential performance impacting problems that include, but are not limited to, rack areas of less accessibility for order pickers, for example, where items are stacked at the back of the rack space, or stacked too high in the rack space, spillage areas, poorly illuminated areas, areas where products of awkward size of shape are more likely to be stacked, or stacked badly, areas where order pickers are more likely to slow down, and areas of greater security risk. Also, the risk map is updated frequently and potentially in real-time to enable speedy adaptation to rapidly changing risk factors, to minimise the damaging effects of rapidly evolving scenarios. Thus, insights obtained from the risk map may be used to improve the warehouse environment design, to increase the operational efficiency and to implement automatic detectors that are able to trigger alarms when an incident happens.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

FIG. 1 illustrates a warehouse environment, wherein various embodiments of the present invention can be practiced;

FIG. 2A illustrates a central processing unit for managing the warehouse environment, in accordance with an embodiment of the present disclosure;

FIG. 2B illustrates a Warehouse Risk Map, in accordance with an embodiment of the present disclosure;

FIG. 3A illustrates an example of a contour plot visualization of the Warehouse Risk Map, in accordance with an embodiment of the present disclosure;

FIG. 3B illustrates an output visualization of the Warehouse Risk Map in the form of a 3D plot in accordance with an embodiment of the present disclosure;

FIG. 4A illustrates a second warehouse environment in accordance with an embodiment of the present disclosure;

FIG. 4B illustrates a New Emerging Risk Discovery (NERD) component for discovering heuristic risks in the second warehouse environment; and

FIG. 5 is a flowchart illustrating a method for identifying and managing areas of risk in the warehouse environment, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF ILLUSTRATIVE EMBODIMENTS

The following detailed description illustrates embodiments of the present disclosure and ways in which they can be implemented. Although the best mode of carrying out the present disclosure has been disclosed, those skilled in the art would recognize that other embodiments for carrying out or practicing the present disclosure are also possible.

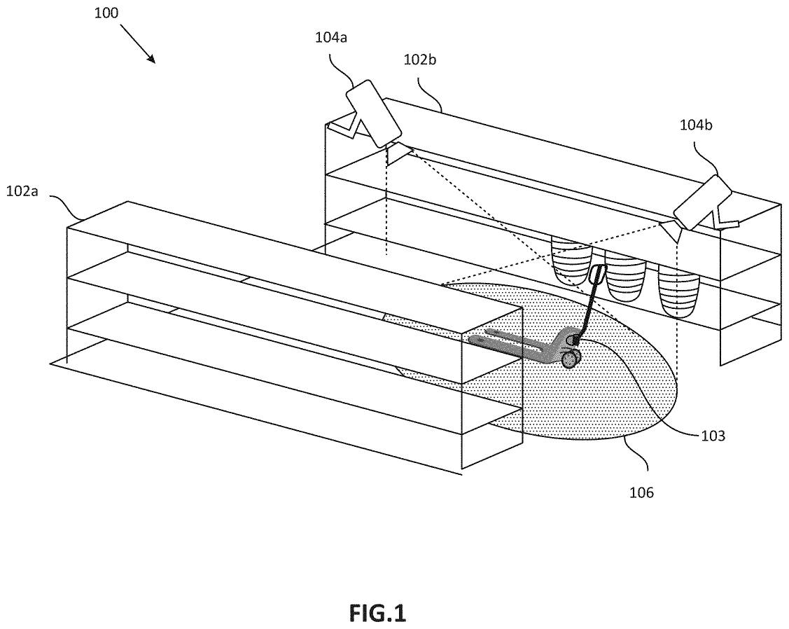

FIG. 1 illustrates a warehouse environment 100, wherein various embodiments of the present invention can be practiced.

The warehouse environment 100 includes first and second storage racks 102a and 102b, and a trolley 103 for transporting goods in the warehouse environment 100. Although, two storage racks are shown herein, it would be apparent to one of skill in the art, that the warehouse environment 100 may include more than two racks and trolley.

The warehouse environment 100 may further include first and second video sensors 104a and 104b fixedly mounted over the first and second racks 102a and 102b respectively. Example of the video sensors 104a and 104b includes, but is not limited to, video cameras. The first and second video sensors 104a and 104b has a Field of View 106 that corresponds to a spatial volume in which the presence of objects may be detected in the absence of obstructions that would otherwise conceal the object. In the context of the present disclosure, the Field of View 106 also covers an Operator Route, where the Operator Route is defined as the path traversed by a warehouse operator during a task period, and the task period is defined as the time period extending from the moment the operator receives a task list from the supervisor until she/he has finished all the tasks on the task list. It should be noted that a task on the task list may include multiple operations such as a handling, order-filling, pallet-loading/unloading, and rack-filling.

The operational efficiency of the warehouse environment 100 is dependent on the dynamic nature of the warehouse environment 100, and the performance of human operators during a pallet handling/order-picking process. A variety of factors influence the pallet handing/order-picking process. These factors are hereinafter referred to as risks.

The incidence of specific types of risks may be monitored in different locations of the warehouse environment 100, according to parameters such as the time/date of the risk incidents or the identity of the operator or the forklift truck etc. The video sensors 104a and 104b may provide more detailed information regarding an operator or the type of handled packages involved in a given risk incident. This may assist warehouse managers in detecting and identifying patterns in risk incidents, for example a warehouse operator A may be more likely to spill items from a pallet close to the first rack 102a, thereby enabling the warehouse managers to undertake appropriate remedial action. The remedial actions may include, but not limited to, improving the lighting close to a rack where lot of risk incidents occur, increasing the spacing between racks or between racks and walls, providing additional training to particular warehouse operators about lifting or stacking items into racks or onto pallets, changing policy regarding the stacking of heavy or large items on different (higher/lower) rack spaces etc.

The individual risks may be expressed as risk instances. A risk instance comprises the following attributes: the classification of the risk, the one or more zones in the warehouse environment 100 where the relevant risk could happen (thereby enabling localization of the risk instance), and the risk level (the probability of the risk occurring in the or each relevant zone). For brevity, the one or more zones in the warehouse environment 100 where a risk could happen may be referred to henceforth as risk zones.

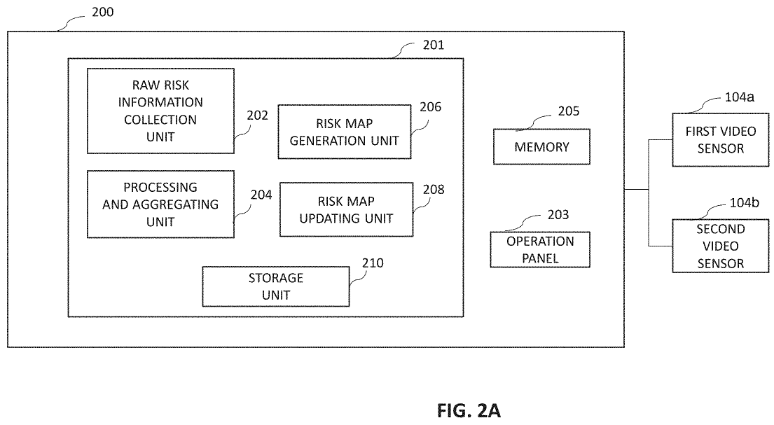

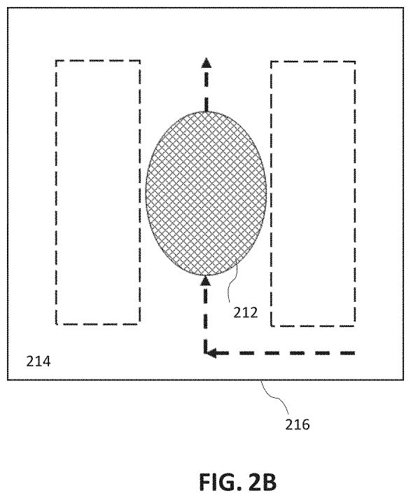

FIG. 2A illustrates a system 200 for managing and monitoring the warehouse environment by identifying and documenting areas of risk, in accordance with an embodiment of the present disclosure.

The system 200 is connected to the first and second video sensors 104a and 104b through a wired or wireless communication network (not shown) to process video streams recorded by the video sensors 104a and 104b.

The system 200 includes a central processing unit (CPU) 201, an operation panel 203, and a memory 205. The CPU 201 is a processor, computer, microcontroller, or other circuitry that controls the operations of various components such as the operation panel 203, and the memory 205. The CPU 201 may execute software, firmware, and/or other instructions, for example, that are stored on a volatile or non-volatile memory, such as the memory 205, or otherwise provided to the CPU 201. The CPU 201 may be connected to the operation panel 203, and the memory 205, through wired or wireless connections, such as one or more system buses, cables, or other interfaces. In an embodiment of the present disclosure, the CPU 201 may include a custom Graphic processing unit (GPU) server software to provide real-time object detection and prediction, for all cameras on a local network.

The operation panel 203 may be a user interface and may take the form of a physical keypad or touchscreen. The operation panel 203 may receive inputs from one or more users relating to selected functions, preferences, and/or authentication, and may provide and/or receive inputs visually and/or audibly.

The memory 205, in addition to storing instructions and/or data for use by the CPU 201, may also include user information associated with one or more users. For example, the user information may include authentication information (e.g. username/password pairs), user preferences, and other user-specific information. The CPU 201 may access this data to assist in providing control functions (e.g. transmitting and/or receiving one or more control signals) related to operation of the operation panel 203, and the memory 205.

In an embodiment of the present disclosure, the CPU 201 includes a raw risk information collection unit 202 for receiving information captured by the video sensors 104a and 104b and storing the information in the storage unit 210, and a processing and aggregating unit 204 configured to process and aggregate video streams to detect the activation by a warehouse operator of one or more trigger conditions associated with one or more risk instances. On detection of the activation of the trigger condition, the processing and aggregating unit 204 is configured to identify and document the attributes of each risk instance.

In the context of the present disclosure, risks may be broadly grouped into two classes, namely predefined risks and heuristic risks. The predefined risks are well-known risks, that may be pre-defined by a management team of the warehouse environment. By contrast, heuristic risks are to be discovered and learned by observation of the warehouse environment. Predefined risks may include risks arising from heavy packages, as heavy packages may cause injuries when they are manipulated by operators. Another example of a predefined risk includes risks arising from fragile packages, as incorrect handling of fragile packages may cause stock and financial loss. While a predefined risk may be established by the management team, the location of occurrences of the said predefined risk may vary with time owing to the dynamic nature of the warehouse environment. For example, the location of heavy and awkwardly-shaped packages on storage racks may change over time.

Localization of a given risk instance may be expressed with different granularities. In particular, whereas a coarse risk localization may rely on identifiers of the racks in the warehouse environment, a fine-grained risk localization may provide more precise location information.

In an embodiment of the present disclosure, the risk level includes two components, namely, recent risk level P_{recent} and global risk level P_{global}. P_{recent} expresses the number of risk incidents that recently occurred in a risk zone as a fraction of the total number of operations undertaken in the risk zone. P_{global} expresses the total number of occurrences of risk incidents in the risk zone since the establishment of the warehouse, as a fraction of the total number of operations undertaken during that time period in that risk zone. P_{recent} and P_{global} respectively contribute 75% and 25% to the overall risk level computation.

More specifically,

L_{magnitude}, magnitude ∈ [1,10],

magnitude=round(10·(3·P_{recent}+P_{global})/4)

P_{recent}=count(incidentsₜ, t ∈ ΔT)/count(operationsₜ), t ∈ ΔT,

P_{global}=count(incidentsₜ)/count(operationsₜ), t ∈ [−∞ . . . now],

where:

round function represents rounding to the nearest integer

count function represents the counting of the number of instances of a considered parameter,

incidentₜ denotes a risk incident that happened at the time t in a given risk zone

operationₜ represents the number of operations (e.g. job-filling, pallet unloading or rack-space packing etc.) undertaken by warehouse operators or other personnel at the time t in the considered risk zone

ΔT is the time interval over which the occurrence of the relevant risk incident is calculated (e.g. ΔT=14 days calculated from now, is used to calculate the number of risk incidents that occurred during the last 14 days).

The central processing unit 201 further includes a risk map generation unit 206 for generating a Warehouse Risk Map 210 (as shown in FIG. 2B) based on the identified risk instances. The Warehouse Risk Map 210 is generated by superimposing an identified risk zone 212 on a two-dimensional map 214 of an observed warehouse environment (showing all racks and operational spaces therein). The Warehouse Risk Map 210 may also show an Operator Route 216 taken by an operator while moving about the warehouse environment.

The Warehouse Risk Map 210 is used to optimize the spatial deployment of video cameras in the warehouse environment so that their collective Field of View cover all the locations associated with each risk instance.

The central processing unit 201 includes a risk map updating unit 208 for updating the Warehouse Risk Map 210 according to a set of one or more of a set of pre-defined triggers (i.e. when there is a change in at least one of the risk types, risk levels, or risk zones) each of which is stored in the storage unit 210 and specifically linked with a given risk type. For example, when heavy packages are moved to another rack, the location of the risk associated with each heavy package changes to the new rack. Similarly, if the heavy packages are replaced with fragile ones, the type of risk changes for that risk instance. This allows fine customization of the moment when an update is necessary for the Warehouse Risk Map 210. For efficiency, not every risk incident occurrence causes an update to the Warehouse Risk Map 210. Additionally, the system settings for risk types and corresponding triggers may be periodically re-configured by the warehouse managers.

In an embodiment of the present disclosure, the risk map updating unit 208 is configured to automatically detect the occurrence of one or more risk incidents, and mark their location on the Warehouse Risk Map 210 to thereby illustrate the risk instances. However, since the location associated with a risk instance may vary with time, the Warehouse Risk Map 210 may be dynamically updated based on a risk-specific trigger to reflect these variations.

In the example of risk incidents arising from heavy packages, the location of such risk incidents may be ascertained from an inventory list of the warehouse environment 100. Thus, a rule for updating the trigger for the corresponding risk instances could be “Update the Warehouse Risk Map 210 every time the inventory list changes”. Similarly, for risk incidents arising from fragile packages, the location of such risk incidents may be ascertained through the detection of damaged packages during order-picking. For example, the occurrence of such risk incidents may be detected by a Package Integrity Check AI (PICAI) component (not shown) of the processing and aggregating unit 204. Thus, a rule for updating the trigger for this risk instance could be “Update the Warehouse Risk Map 210 every time the PICAI detects a damaged package”.

The PICAI determines package integrity status by processing video data captured by the video sensors 104a and 104b. More specifically, the PICAI comprises a trained deep neural network classifier (not shown) adapted to process a video stream from a video camera positioned to monitor the warehouse environment where packages are manipulated. The PICAI classifier may implement an architecture such as a visual geometry group (VGG) or a residual neural network (Resnet), and may be trained with a set of images labelled into two classes, namely damaged and non-damaged packages.

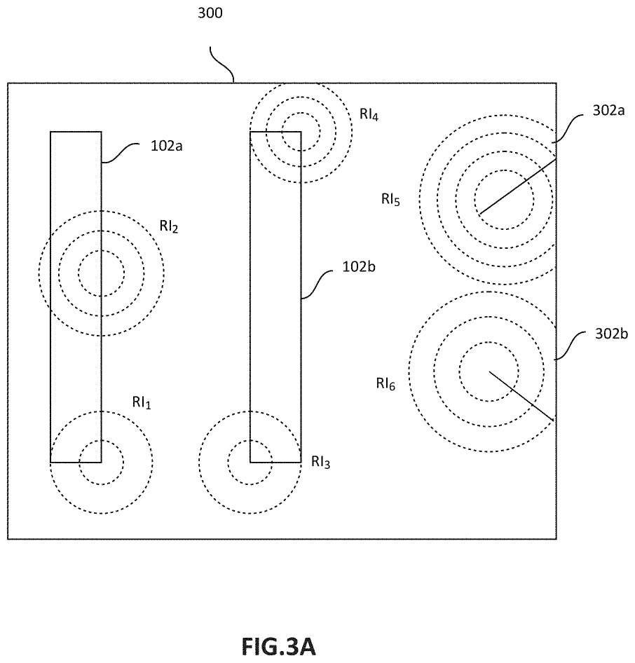

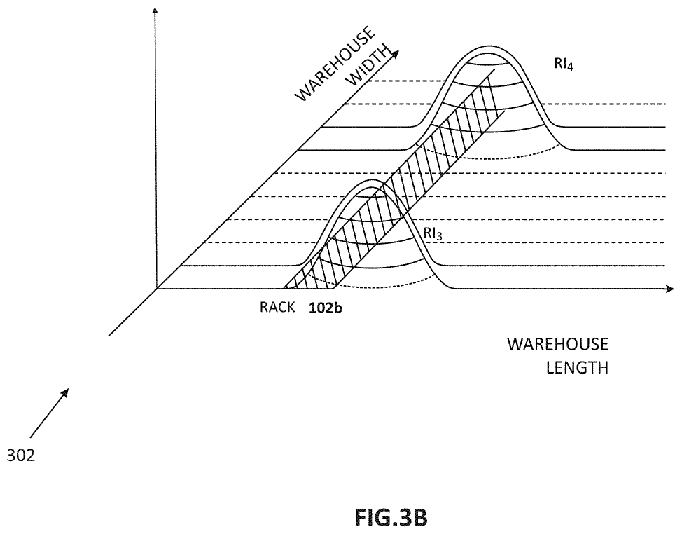

FIG. 3A illustrates an example of a contour plot visualization 300 of the Warehouse Risk Map in a warehouse environment comprising two racks 102a and 102b and two doors 302a and 302b, in accordance with an embodiment of the present disclosure. The contour plot visualization 300 is a visual output interface for warehouse managers that provides a perspective view on the cumulative occurrence of individual risk types at given locations in the warehouse environment. In the present example, the contour plot visualization 300 shows the presence of six risk incident hotspots (RI₁ to RI₆) in the warehouse environment. In this way, the contour plot visualization 300 supports the targeting of monitoring resources on areas of the warehouse environment where higher numbers of risk incidents have been observed.

FIG. 3B illustrates the output visualization of the Warehouse Risk Map in the form of a 3D plot 302 that shows an overall risk landscape in the warehouse environment through the elevation axis, in accordance with an embodiment of the present disclosure. The 3D plot 302 is an example of a 3D visualization of the Warehouse Risk Map for the first rack 102b in the warehouse environment of FIG. 3A, showing two risk incident (RI₃ to RI₄) hotspots connected with the first rack 102b.

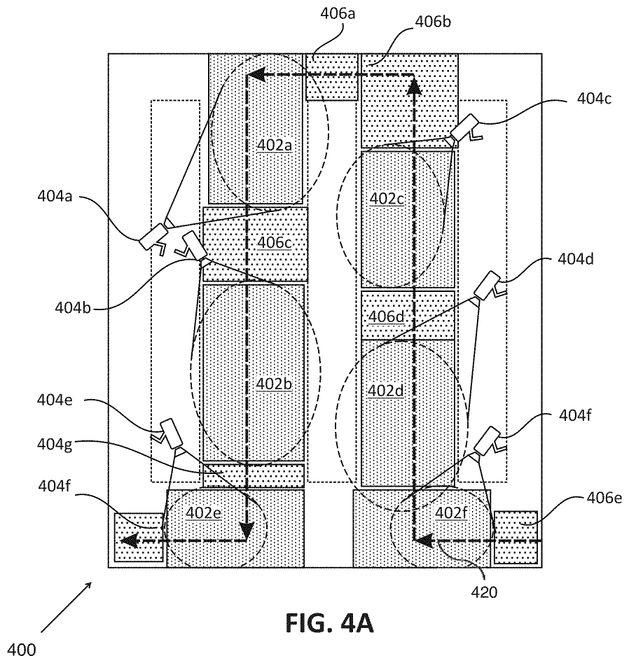

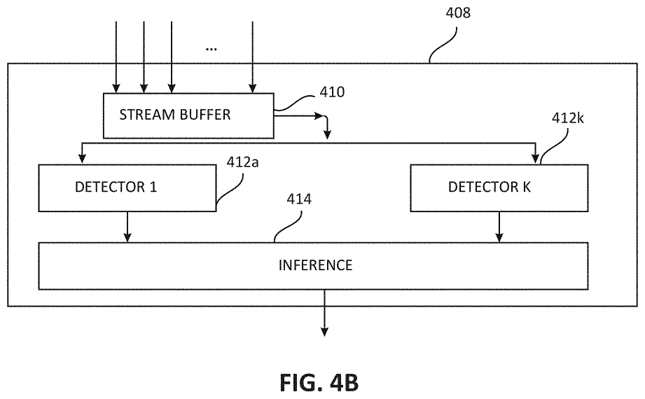

FIG. 4A illustrates a second warehouse environment 400 in accordance with an embodiment of the present disclosure. It would be apparent to one of ordinary skill in the art, that the first and second warehouse environment 100 and 400 may be the same.

The second warehouse environment 400 includes first through sixth Monitored Zones (MZᵢ) 402a till 402f (hereinafter collectively referred to as Monitored Zones 402) monitored by corresponding video sensors 404a till 404f with respective Fields of View. A Monitored Zone is substantially rectangular in shape, and its area is limited by the Field of View of the corresponding monitoring video sensor (i.e. video camera).

The second warehouse environment 400 includes first through seventh Uncovered Zones (UZⱼ) 406a till 406g (hereinafter collectively referred to as Uncovered Zones 406) which the video sensors 404a till 404f are unable to monitor. An Uncovered Zone (UZⱼ) j∈ [1 . . . M], where M is equal to the total number of such Uncovered Zones, may be an aperture (if any) between two consecutive Monitored Zones, or an aperture between a Monitored Zone and a proximal wall of the warehouse. Each successive Uncovered Zone is conferred with a unique identifier, for example, an index j incrementing from 1 according to the requirements of the warehouse management.

FIG. 4B illustrates a New Emerging Risk Discovery (NERD) component 408 for discovering heuristic risks in the second warehouse environment 400, in accordance with an embodiment of the present disclosure.

The NERD component 408 is communicatively coupled to the set of video sensors (404a till 404f in FIG. 4A) either through a wired or a wireless communication network. Based on the input from the video sensors, the NERD component 408 is configured to determine the time spent by an operator traversing a Monitored Zone (MZᵢ), time spent by an operator traversing an Uncovered Zone (UZⱼ), object handling actions (pick/drop) in a Monitored Zone (MZᵢ) and/or an Uncovered Zone (UZⱼ), multiple handling actions of a same object within a Monitored Zone (MZᵢ) and/or an Uncovered Zone (UZⱼ); the operator movement pattern (e.g. list of trajectory segments) in a Monitored Zone (MZᵢ) and/or an Uncovered Zone (UZⱼ).

In an embodiment of the present disclosure, the NERD component 408 includes a stream buffer 410 for receiving and buffering video streams from the video sensors (404a till 404f in FIG. 4A), a set of first through kth detectors 412a till 412k, and an inference unit 414. Although, the NERD component 408 is shown to be an independent component communicatively coupled to the set of video sensors (404a till 404f in FIG. 4A), it would be apparent to one of ordinary skill in the art, that the NERD component 408 may be a part of the central processing unit (201 in FIG. 2A).

In an embodiment of the present disclosure, the first through k^{th} detectors 412a till 412k are configured to process the video streams from video sensors (404a till 404f in FIG. 4A). The first through k^{th} detectors 412a till 412k may include one or more detectors that implement human detection and tracking algorithms to determine the time spent by an operator in each location of the warehouse along an Operator Route (420 in FIG. 4A); to parse manager's reports; and to determine the number of risk incidents occurring at a given location in the warehouse.

The inference unit 414 is configured to learn “normal” operational parameters expressed as time spent by an operator in a given zone of the warehouse, and to identify abnormalities suggestive of the occurrence of a new risk type, for example, excessive time spent by an operator in the said zone.

Referring to FIG. 4B together with FIG. 4A, in an embodiment of the present disclosure, the NERD component 408 is configured to combine the results from individual Monitored Zones 402 to thereby monitor a significant proportion of the warehouse environment 400. In an embodiment of the present disclosure, an operator's movements about the warehouse may be effectively tracked by combining successive monitored zones 402 along the Operator Route 420. Thus, an Operator Route 420 taken by an operator may be described by a series of N successive Monitored Zones (MZᵢ) i∈ [1 . . . N], wherein the index i is set to a value of 1 at the start of the route and is incremented by one for each Monitored Zone (MZᵢ) entered by the operator while progressing along the Operator Route 420. As the Operator Route 420 is covered by the Fields of View of consecutive video sensors (404a till 404f), the location of the operator can be tracked through the identity of the video sensor whose Field of View captures the operator. For example, an operator following the Operator Route 420 may traverse the Field of Views of the video sensors 404f, 404d, 404c, 404a, 404b, and 404e. Therefore, corresponding Monitored Zones 402a-402f may be linked in a given risk instance, i.e. risk location parameter corresponding to the identity/label of the video sensor that captured an operator involved in a risk incident, to thereby link the risk incident with the relevant Monitored Zone 402a-402f.

In an embodiment of the present disclosure, the Monitored Zones may have a numbering scheme based on identifiers of video sensors positioned to capture video footage in the respective monitored zones. Alternatively, the Monitored Zones may have a fixed numbering scheme (independent of the route taken by a warehouse operator) according to the requirements of the warehouse managers.

In entirety, the NERD component 408 processes the video data captured by the array of video sensors (404a till 4040 to create new heuristic risk types. Using this, a corresponding risk instance may be created based on observations of different process anomalies in each Monitored Zone and/or Uncovered Zone along the Operator Route.

In an example, a risk of excessive time spent by operator in a particular zone of the warehouse may be determined by comparing the time interval spent by an operator in the various Monitored Zones and/or Uncovered Zones along the Operator Route 420, against an expected “normal” time interval spent in the relevant warehouse zone. This risk may indicate the slowing-down of an activity/process undertaken in the warehouse zone. The “normal” time interval spent in the warehouse zone may be estimated as an average of the time intervals spent therein during a past pre-defined number of weeks. Also, the “normal” time interval may be estimated by observing a predefined number of the instances of the process performed in the relevant warehouse zone. Alternatively, the “normal” time interval may be estimated by calculating the average time spent in each Monitored Zone and/or Uncovered Zone along the Operator Route 420 during a pre-defined number (N) of previous days. For this risk type, a rule for updating the trigger could be “Update the Warehouse Risk Map 210 in FIG. 2B) every time the NERD component 408 detects excessive time being repeatedly spent in a Monitored Zone and/or Uncovered Zone”. The NERD component 408 creates the risk instances for heuristic risks and implements an update process through the activation of triggers in an analogous manner to that described for pre-defined risks. For the example mentioned above, the trigger can be activated according to the measured time interval spent by an operator in a given warehouse zone.

In another example, warehouse zones where risk incidents occur frequently, may be discovered by establishing a threshold for the number of process interruptions caused by the occurrence of various uncategorized/unknown incidents in Monitored Zones and/or Uncovered Zones. Such incidents may be reported by a warehouse manager, and may, for example, be caused by overly narrow aisles/spacing between racks, preventing items from being packed securely in the racks, so that packages fall from the rack. For this risk type, a rule for an update trigger could be “Update the Warehouse Risk Map (210 in FIG. 2B) every time a manager reports a new incident in a relevant Monitored Zone and/or Uncovered Zone”. The NERD component 408 detects the risk by automatically parsing manager reports to count the number of reported incidents according to the warehouse zones in which the incidents occurred. On detection of an excessive number of reported incidents in a given warehouse zone, the NERD component 408 creates a new risk instance, with a risk type attribute set to “Bermuda Triangle”; and the location of the risk set to the identifier of the relevant warehouse zone. The NERD component 408 then updates the Warehouse Risk Map (210 in FIG. 2B) to include the created risk instance.

Thus, identification of risk areas allows the warehouse managers/operators to quickly take remedial action to address the cause thereof. More importantly, informed decision-making regarding pro-active measures may be taken including redesigning aspects of the warehouse to prevent or minimize the effect of the risk factors. The redesigning aspects may include redefining and/or improving manipulation procedures, redesigning the physical and logistics aspects of the warehouse environment, improving packing/stacking criteria, planning better order pickers routes, implementing enhanced (environmental and operator) monitoring etc.

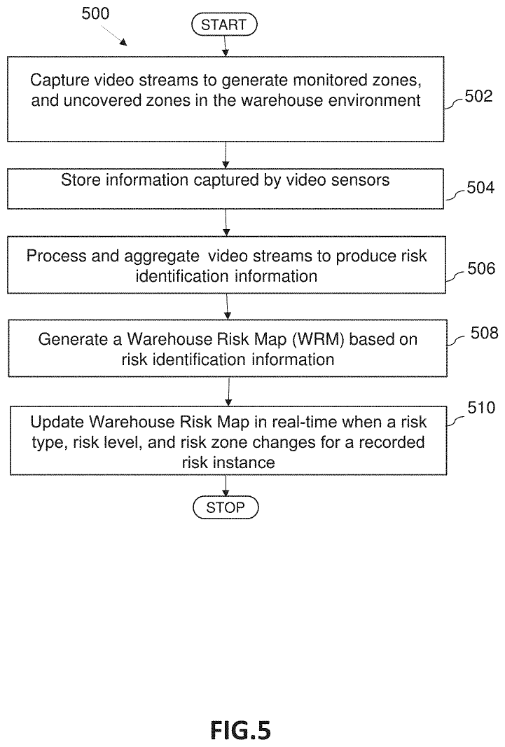

FIG. 5 is a flowchart illustrating a method for identifying and managing areas of risk in a warehouse environment of FIGS. 1A and 4A, in accordance with an embodiment of the present disclosure. This method, and each method described herein, may be implemented by the architectures described herein or by other architectures. The method is illustrated as a collection of blocks in a logical flow graph. Some of the blocks represent operations that can be implemented in hardware, software, or a combination thereof. In the context of software, the blocks represent computer-executable instructions stored on one or more computer readable media that, when executed by one or more processors, perform the recited operations. Generally, computer-executable instructions include routines, programs, objects, components, data structures, and the like that perform particular functions or implement particular abstract data types.

The computer readable media may include non-transitory computer readable storage media, which may include hard drives, floppy diskettes, optical disks, CD-ROMs, DVDs, read-only memories (ROMs), random access memories (RAMs), EPROMs, EEPROMs, flash memory, magnetic or optical cards, solid-state memory devices, or other types of storage media suitable for storing electronic instructions. In addition, in some implementations, the computer readable media may include a transitory computer readable signal (in compressed or uncompressed form). Examples of computer readable signals, whether modulated using a carrier or not, include, but are not limited to, signals that a computer system hosting or running a computer program can be configured to access, including signals downloaded through the Internet or other networks. Finally, the order in which the operations are described is not intended to be construed as a limitation, and any number of the described operations can be combined in any order and/or in parallel to implement the process.

At step 502, each Field of View of one or more video sensors installed in a warehouse environment are used to generate one or more Monitored Zones, and one or more Uncovered Zones therein. The one or more sensors have a Field of View that corresponds to a spatial volume in which the presence of objects may be detected in the absence of obstructions that would otherwise conceal the object. In the context of the present disclosure, the Field of View also covers an Operator Route, where the Operator Route is defined as the path traversed by a warehouse operator during the during a task period, and the task period is defined as the time period extending from the moment the operator receives a task list from the supervisor until she/he has finished all the tasks on the task list. It should be noted that a task on the task list may include multiple operations such as a handling, order-filling, pallet-loading/unloading, and rack-filling. At step 504, information comprising video streams captured by each video sensor is stored.

At step 506, each of the video streams are processed and aggregated to produce information regarding risk instances associated with an Operator Route followed by a warehouse operator while performing a warehouse operation, wherein the risk identification information includes at least one risk zone, and corresponding risk type, and risk level, wherein a risk zone is an area in the warehouse environment that corresponds to one or more risk instances. In an embodiment of the present disclosure, the warehouse operation is selected from at least one of: a handling task, an order filling task, a pallet loading/unloading task, and a rack filling task. A risk is selected from at least one of: a predefined risk arising from a heavy package, a predefined risk arising from a fragile package and a heuristic risk. In an embodiment of the present disclosure, the occurrence of one or more pre-defined risks is detected, and the location of each risk is marked on a Warehouse Risk Map to thereby illustrate corresponding risk instances. In an example, the pre-defined risk includes a risk arising from heavy packages, the location of the said risk is determined from an inventory list, and the corresponding Warehouse Risk Map is updated, each time the inventory list changes.

In an embodiment of the present disclosure, one or more heuristic risks are determined by comparing the time spent by the operator, object handling actions, and the operator's movement pattern with a corresponding pre-defined time spent by the operator, a pre-defined object handling action, and a pre-defined operator movement pattern.

At step 508, a Warehouse Risk Map is generated based on the risk instances information, wherein the Warehouse Risk Map is generated by superimposing an identified risk zone on a two-dimensional map of an observed warehouse environment. The superimposing risk zones are partially overlapped zones (areas) on the map which corresponds to two different risk instances such as first and second racks. The Warehouse Risk Map is used to optimize the spatial deployment of video cameras in the warehouse environment so that their collective Field of View cover all the locations associated with each risk instance.

At step 510, the Warehouse Risk Map is updated in real-time when at least one of the risk type, risk level, and risk zone changes for at least one risk instance recorded on the Warehouse Risk Map. In an embodiment of the present disclosure, a risk level for a risk zone is computed based on probability of a particular risk incident happening at the risk zone, the risk level including two components, a recent risk level, and a global risk level, where the recent risk level expresses a number of risk incidents that recently occurred in the risk zone as a fraction of total number of operations undertaken in the risk zone, and the global risk level expresses a total number of occurrences of risk incidents in the risk zone as a fraction of the total number of operations undertaken.

Modifications to embodiments of the present disclosure described in the foregoing are possible without departing from the scope of the present disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

We claim:

1. A system for identifying and managing areas of risk in a warehouse environment, the system comprising:
one or more video sensors configured to capture one or more video streams thereof, to generate one or more monitored zones, and one or more uncovered zones in the warehouse environment, based on a field of view of the one or more video sensors; and
a central processing unit communicatively coupled to the one or more video sensors, and comprises:
a raw risk information collection unit configured to store information captured by the one or more video sensors;
a processing and aggregating unit configured to process and aggregate the one or more video streams to produce risk identification information associated with an Operator Route traversed by a warehouse operator while performing a warehouse operation, wherein the risk identification information includes at least one risk zone, a corresponding risk type, and a risk level, wherein the at least one risk zone is an area in the warehouse environment that corresponds to one or more risk instances;
a risk map generation unit configured to generate a Warehouse Risk Map based on the risk identification information, wherein the Warehouse Risk Map is generated by superimposing at least one identified risk zone on a warehouse map; and
a risk map updating unit for updating the Warehouse Risk Map in real-time on a condition that at least one of the risk type, risk level, and risk zone changes for at least one risk instance recorded on the Warehouse Risk Map.

2. The system of claim 1, wherein the warehouse operation is selected from at least one of: a handling task, an order filling task, a pallet loading/unloading task, and a rack filling task.

3. The system of claim 1, wherein a risk is selected from at least one of: a predefined risk arising from a heavy package, a predefined risk arising from a fragile package and a heuristic risk.

4. The system of claim 1, wherein a risk level for a risk zone is computed based on probability of a particular risk incident happening at the risk zone, the risk level including two components, a recent risk level, and a global risk level, where the recent risk level expresses a number of risk incidents that recently occurred in the risk zone as a fraction of total number of operations undertaken in the risk zone, and the global risk level expresses a total number of occurrences of risk incidents in the risk zone as a fraction of the total number of operations undertaken.

5. The system of claim 1, wherein the risk map updating unit is further configured to automatically detect occurrence of one or more pre-defined risks, and mark corresponding localization on the Warehouse Risk Map to thereby define corresponding risk instances.

6. The system of claim 5, wherein the pre-defined risk includes a risk arising from heavy packages, and localization of the risk is extracted from an inventory list, and wherein the risk map updating unit is configured to update corresponding risk map, each time the inventory list changes.

7. The system of claim 1, wherein the processing and aggregating unit comprises a Package Integrity Check AI (PICAI) component configured to identify one or more damaged packages in the warehouse environment based on the one or more video streams.

8. The system of claim 1, wherein the central processing unit comprises a New Emerging Risk Discovery (NERD) component for discovering one or more heuristic risks in the warehouse environment, wherein the NERD component comprises:
a stream buffer configured to receive and buffer the one or more video streams from the video sensors;
a set of detectors that implement human detection and tracking algorithms to determine time spent by an operator in each monitored/uncovered zone, monitor object handling actions in each monitored/uncovered zone, and operator movement pattern in each monitored/uncovered zone; and
an inference unit configured to determine one or more heuristic risks by comparing time spent by the operator, object handling actions, and the operator movement pattern with corresponding pre-defined time spent by the operator, a pre-defined object handling action, and the pre-defined operator movement pattern.

9. A method for identifying and managing areas of risk in a warehouse environment, the method comprising:
capturing one or more video streams thereof, to generate one or more monitored zones, and one or more uncovered zones in the warehouse environment, based on a field of view of the one or more video sensors;
storing information captured by the one or more video sensors;
processing and aggregating the one or more video streams to produce risk identification information associated with an Operator Route traversed by a warehouse operator while performing a warehouse operation, wherein the risk identification information includes at least one risk zone, a corresponding risk type, and a risk level, wherein the at least one risk zone is an area in the warehouse environment that corresponds to one or more risk instances;
generating a Warehouse Risk Map based on the risk identification information, wherein the Warehouse Risk Map is generated by superimposing at least one identified risk zone on a warehouse map; and
updating the Warehouse Risk Map in real-time on a condition that at least one of the risk type, risk level, and risk zone changes for at least one risk instance recorded on the Warehouse Risk Map.

10. The method of claim 9, wherein the warehouse operation is selected from at least one of: a handling task, an order filling task, a pallet loading/unloading task, and a rack filling task.

11. The method of claim 9, wherein a risk is selected from at least one of: a predefined risk arising from a heavy package, a predefined risk arising from a fragile package and a heuristic risk.

12. The method of claim 9, wherein a risk level for a risk zone is computed based on probability of a particular risk incident happening at the risk zone, the risk level including two components, a recent risk level, and a global risk level, where the recent risk level expresses a number of risk incidents that recently occurred in the risk zone as a fraction of total number of operations undertaken in the risk zone, and the global risk level expresses a total number of occurrences of risk incidents in the risk zone as a fraction of the total number of operations undertaken.

13. The method of claim 9 further comprising automatically detecting occurrence of one or more pre-defined risks, and marking corresponding localization on the Warehouse Risk Map to thereby define corresponding risk instances.

14. The method of claim 13, wherein the pre-defined risk includes a risk arising from heavy packages, and localization of the risk is extracted from an inventory list, and corresponding risk map is updated, each time the inventory list changes.

15. The method of claim 9 further comprising identifying one or more damaged packages in the warehouse environment based on the one or more video streams.

16. The method of claim 9 further comprising:
receiving and buffering the one or more video streams from the video sensors;
determining time spent by an operator in each monitored/uncovered zone, monitoring object handling actions in each monitored/uncovered zone, and operator movement pattern in each monitored/uncovered zone; and
determining one or more heuristic risks by comparing time spent by the operator, object handling actions, and the operator movement pattern with corresponding pre-defined time spent by the operator, a pre-defined object handling action, and the pre-defined operator movement pattern.

17. A computer programmable product for identifying and managing areas of risk in a warehouse environment, the computer programmable product comprising a set of instructions stored on a non-transitory computer readable medium, the set of instructions when executed by a processor causes the processor to:
capture one or more video streams thereof, to generate one or more monitored zones, and one or more uncovered zones in the warehouse environment, based on a field of view of the one or more video sensors;
store information captured by the one or more video sensors;
process and aggregate the one or more video streams to produce risk identification information associated with an Operator Route traversed by a warehouse operator while performing a warehouse operation, wherein the risk identification information includes at least one risk zone, a corresponding risk type, and a risk level, wherein the at least one risk zone is an area in the warehouse environment that corresponds to one or more risk instances;
generate a Warehouse Risk Map based on the risk identification information, wherein the Warehouse Risk Map is generated by superimposing at least one identified risk zone on a warehouse map; and
update the Warehouse Risk Map in real-time on a condition that at least one of the risk type, risk level, and risk zone changes for at least one risk instance recorded on the Warehouse Risk Map.

18. The computer programmable product of claim 17, wherein a risk level for a risk zone is computed based on probability of a particular risk incident happening at the risk zone, the risk level including two components, a recent risk level, and a global risk level, where the recent risk level expresses a number of risk incidents that recently occurred in the risk zone as a fraction of total number of operations undertaken in the risk zone, and the global risk level expresses a total number of occurrences of risk incidents in the risk zone as a fraction of the total number of operations undertaken.

19. The computer programmable product of claim 17, wherein the set of instructions when executed by the processor causes the processor to automatically detect occurrence of one or more pre-defined risks, and mark corresponding localization on the Warehouse Risk Map to thereby define corresponding risk instances.

20. The computer programmable product of claim 17, wherein the set of instructions when executed by the processor causes the processor to:
receive and buffer the one or more video streams from the video sensors;
determine time spent by an operator in each monitored/uncovered zone, monitor object handling actions in each monitored/uncovered zone, and operator movement pattern in each monitored/uncovered zone; and
determine one or more heuristic risks by comparing time spent by the operator, object handling actions, and the operator movement pattern with corresponding pre-defined time spent by the operator, a pre-defined object handling action, and the pre-defined operator movement pattern.
